(19) United States
(12) Patent Application Publication
(10) Pub. No.: US 2017/0155753 A1
(43) Pub. Date: Jun. 1, 2017

(54) INTERFACE DISPLAY METHOD AND APPARATUS

(71) Applicant: Xiaomi Inc., Beijing (CN)

(72) Inventors: Dalong SHI, Beijing (CN); Liang QIAO, Beijing (CN); Shangyou HAN, Beijing (CN)

(73) Assignee: Xiaomi Inc., Beijing (CN)

(21) Appl. No.: 15/361,802

(22) Filed: Nov. 28, 2016

(30) Foreign Application Priority Data
Nov. 27, 2015 (CN) 201510848015.8

(51) Int. Cl. H04M 1/725; G06F 3/0481

(52) U.S. Cl. CPC H04M 1/72552; H04M 1/72572; H04M 1/72586; G06F 3/0481; H04M 2242/12; H04M 2242/15

(57) ABSTRACT

An interface display method and apparatus are provided. The method includes: transmitting location information to a server, receiving a dialect from the server where the dialect corresponds to the location information that the server acquires, and displaying a user interface including a dialect operation item according to the dialect where the dialect operation item is an operation item expressed using an expression in the dialect.

### CROSS-REFERENCE TO RELATED APPLICATION

This application is based on and claims priority of the Chinese Patent Application No. 201510848015.8, filed on Nov. 27, 2015, which is incorporated herein by reference in its entirety.

### TECHNICAL FIELD

The present application is related to the field of information display, and more particularly, to an interface display method and apparatus.

### BACKGROUND

A user interface is an important integral part of an application that runs on a smart device. When the smart device runs the application to present the user interface to different users, each of the different users may view the user interface at the same time. However, different users may speak different languages, and each language may have different dialects. As such, it's preferable to display the user interface on a smart device for a user according to the user's habit. However, technical challenges exist to automatically determine and display the user interface on a smart device according to the user's habit.

### SUMMARY

According to a first aspect of embodiments of the present disclosure, an interface display method is provided. The method may include: transmitting location information to a server, receiving a dialect from the server where the dialect corresponds to the location information that the server acquires, and displaying a user interface including a dialect operation item according to the dialect where the dialect operation item is an operation item expressed using an expression in the dialect.

According to a second aspect of the embodiments of the present disclosure, an interface display method is provided. The method may include: receiving location information of a terminal from the terminal, acquiring a dialect corresponding to the location information, and returning the dialect to the terminal where the dialect is used by the terminal to display a user interface including a dialect operation item according to the dialect and the dialect operation item is an operation item expressed using an expression in the dialect.

According to a third aspect of the embodiments of the present disclosure, an interface display apparatus is provided. The apparatus may include: a transmitting module configured to transmit location information to a server; a receiving module configured to receive a dialect from the server where the dialect corresponds to the location information that the server acquires, and a displaying module configured to display a user interface including a dialect operation item according to the dialect where the dialect operation item is an operation item expressed using an expression in the dialect.

According to a fourth aspect of the embodiments of the present disclosure, an interface display apparatus is provided. The apparatus may include: a receiving module configured to receive location information of a terminal from the terminal, an acquiring module configured to acquire a dialect corresponding to the location information, and a returning module configured to return the dialect to the terminal where the dialect is used by the terminal to display a user interface including a dialect operation item according to the dialect, and the dialect operation item is an operation item expressed using an expression in the dialect.

According to a fifth aspect of the embodiments of the present disclosure, an interface display apparatus is provided. The apparatus may include: a processor, and a memory for storing instructions executable by the processor. The processor is configured to: transmit location information to a server, receive a dialect from the server where the dialect corresponds to the location information that the server acquires, and display a user interface including a dialect operation item according to the dialect where the dialect operation item is an operation item expressed using an expression in the dialect.

According to a sixth aspect of the embodiments of the present disclosure, an interface display apparatus is provided. The apparatus may include: a processor, and a memory for storing instructions executable by the processor. The processor is configured to: receive location information of a terminal from the terminal, acquire a dialect corresponding to the location information, and return the dialect to the terminal where the dialect is used by the terminal to display a user interface including a dialect operation item according to the dialect, and the dialect operation item is an operation item expressed using an expression in the dialect.

It should be understood that both the foregoing general description and the following detailed description are exemplary only and are not restrictive of the disclosure.

### BRIEF DESCRIPTION OF THE DRAWINGS

The disclosed embodiments will be better understood and features, aspects and advantages other than those set forth above will become apparent when consideration is given to the following detailed description thereof. Such detailed description makes reference to the following drawings.

FIG. 1 is a flow chart showing an interface display method according to an exemplary embodiment;

FIG. 2A is a flow chart showing another interface display method according to an exemplary embodiment;

FIG. 2B is a schematic drawing showing an interface according to an exemplary embodiment;

FIG. 2C is a schematic drawing showing another interface according to an exemplary embodiment;

FIG. 2D is a schematic drawing showing a further interface according to an exemplary embodiment;

FIG. 3 is a flow chart showing another interface display method according to an exemplary embodiment;

FIG. 4 is a block diagram showing an interface display apparatus according to an exemplary embodiment;

FIG. 5 is a block diagram showing an interface display apparatus according to another exemplary embodiment;

FIG. 6 is a block diagram showing an interface display apparatus according to another exemplary embodiment;

FIG. 7 is a block diagram showing an interface display apparatus according to an exemplary embodiment; and

FIG. 8 is a block diagram showing an interface display apparatus according to a further exemplary embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the disclosure. Instead, they are merely examples of apparatuses and methods consistent with aspects related to the disclosure as recited in the appended claims.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

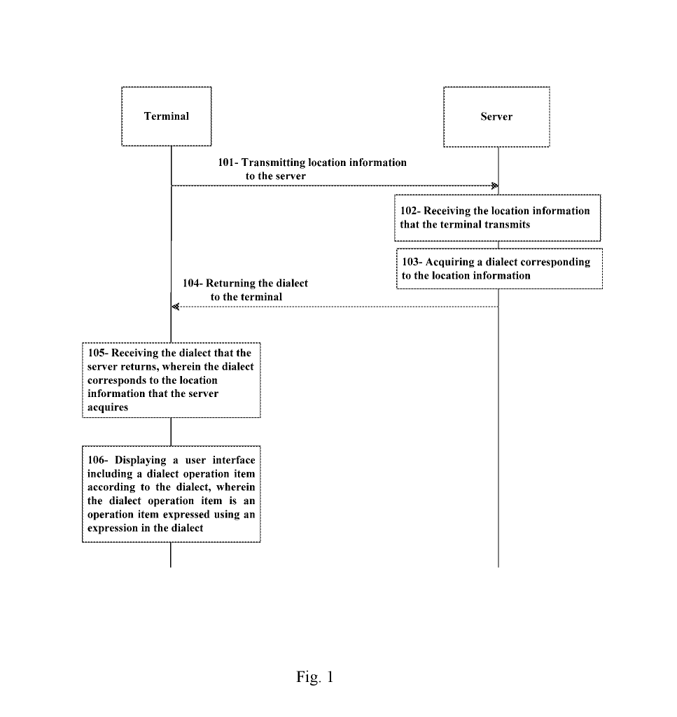

FIG. 1 is a flow chart showing an interface display method according to an exemplary embodiment. The method may include the following steps.

At step 101, a terminal transmits location information to a server.

The terminal may be any devices that has a user interface such as a mobile phone, tablet, smart watch, TV or a monitor that connects to a computer. When the terminal is a mobile phone, the location information includes at least one of: a mobile phone number and geographical location information of the terminal obtained by positioning the terminal. The mobile phone number may be used by the server to determine an area to which the mobile phone belongs according to home location information of the mobile phone number. The server may return a dialect corresponding to the area. The geographical location information may be used by the server to determine an area to which the terminal belongs according to the geographical location information. The server may return a dialect corresponding to the area.

When the terminal is not a mobile phone but has a positioning function, such as a tablet or the like, the location information includes geographical location information of the terminal obtained by positioning the terminal. The terminal positioning may be conducted by using any positioning method and/or device. For example, positioning the terminal may be conducted by using the global positioning system (GPS) to identify the location information of the terminal.

When the terminal is the one that has no positioning function but has a networking function. For example, the terminal is a desktop computer and the like. The location information may include an Internet Protocol (IP) address used by the terminal for networking. The IP address can be used by the server to determine an area to which the terminal belongs according to the IP address. The server can acquire and return a dialect corresponding to the area.

At step 102, the server receives the location information of the terminal that the terminal transmits.

At step 103, the server acquires a dialect corresponding to the location information.

At step 104, the server returns the dialect to the terminal.

A dialect may be a particular form of a language that is peculiar to a specific region or a social group. The term dialect is applied most often to regional speech patterns. Any variety of a language constitutes “a dialect”, including any standard varieties. A dialect may also be associated with a particular social class. For example, a dialect that is associated with a particular ethnic group.

The dialect can be used by the terminal to display a user interface including a dialect operation item according to the dialect, and the dialect operation item is an operation item expressed using an expression in the dialect.

At step 105, the terminal receives a dialect from the server, where the dialect corresponds to the location information that the server acquires.

At step 106, the terminal displays a user interface including a dialect operation item according to the dialect, and the dialect operation item is an operation item expressed using an expression in the dialect.

To sum up, in the method provided by this embodiment, location information is transmitted to a server, the server acquires and returns a dialect corresponding to the location information, and a terminal displays a user interface including a dialect operation item according to the received dialect, where the dialect operation item is an operation item expressed using an expression in the dialect. Without using this method, the problem may exist when a default operation item presented by a terminal does not conform to reading habits of a user and thus the interface display may not be user friendly to the user. By using this method, an operation item is expressed in the user interface using an expression in a user's dialect and the user's reading habits are conformed. Hence, by using this method, a user interface including a dialect operation item is displayed such that the interface display is more user friendly than the user interface without using this method.

In a practical implementation, the step 101 may be implemented in the following two possible manners.

In the first manner, at least one of: a mobile phone number of a terminal and geographical location information of the terminal obtained by positioning the terminal is transmitted to a server. The mobile phone number is used by the server determines an area to which the terminal belongs according to home location information of the mobile phone number. The server returns a dialect corresponding to the area. The geographical location information is used by the server to determine an area to which the terminal belongs according to the geographical location information and the server returns a dialect corresponding to the area.

In the second manner, an IP address of a terminal is transmitted to a server. The IP address is used by the server to determine an area to which the terminal belongs according to the IP address and the server acquires and returns a dialect corresponding to the area.

Accordingly, the above two manners will be described in detail in two different embodiments below.

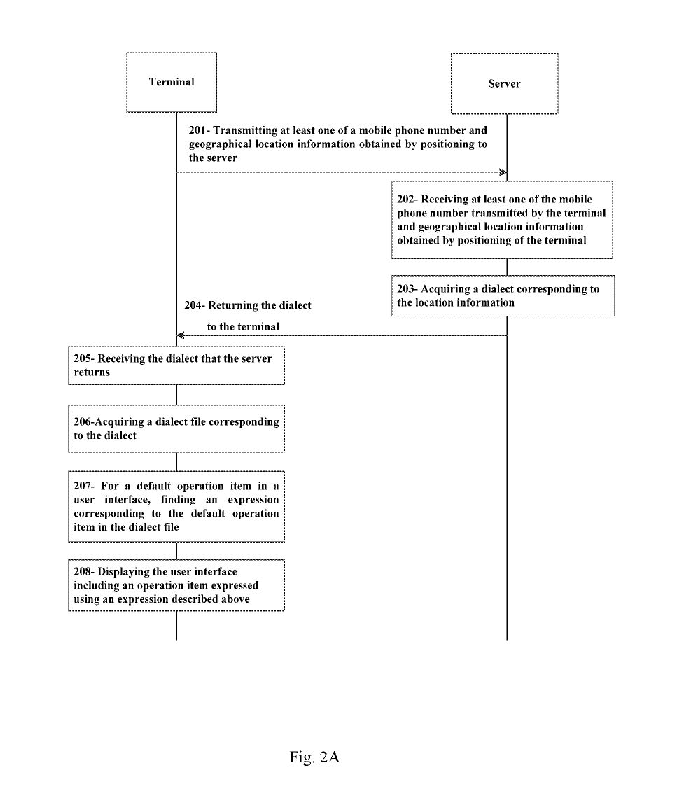

FIG. 2A is a flow chart showing another interface display method according to an exemplary embodiment. This embodiment is illustrated by way of example where a terminal transmits location information to a server in the first manner described above. As shown in FIG. 2A, the method may include the following steps.

At step 201, the terminal transmits to the server at least one of: a mobile phone number and geographical location information of the terminal obtained by positioning the terminal.

When the terminal is a mobile phone, the mobile phone transmits to the server at least one of: the mobile phone number and geographical location information of the terminal obtained by positioning the terminal. The mobile phone number is used by the server to determine an area to which the mobile phone belongs according to home location information of the mobile phone number and the server returns a dialect corresponding to the area. The geographical location information is used by the server to determine an area to which the terminal belongs according to the geographical location information and the server returns a dialect corresponding to the area.

A mobile phone number has a uniform coding format. For example, digits 4 through 7 of the mobile phone number in China may represent an area code that is used to indicate a home location of the mobile phone number. The mobile phone can transmit the mobile phone number to the server. In a practical implementation, in order to reduce network resources that need to be occupied when the mobile phone transmits the location information, the mobile phone can transmit the first 7 digits of the mobile phone number to the server. Some other methods may also be developed to save the network resources. For example, the terminal may just transmit digits 4-7 of the mobile phone number to the server.

The mobile phone may have different coding formats. Sometimes, the first 3 digits of the mobile phone number may be the area code that can be used to determine the home location of the mobile phone. For example, in the United States, when the first 3 digits of a mobile phone number are “312,” the home location for the mobile phone may be in the Chicago area. For this case, to save the network resources, only the first 3 digits of the mobile phone number may be transmitted to the server.

The mobile phone can obtain its own geographical location information (generally represented by latitude and longitude information) by using GPS positioning, and after that, the mobile phone can transmit the geographical location information of the terminal obtained by using the GPS positioning to the server.

When the terminal is not a mobile phone but has a positioning function, such as a tablet and the like, the terminal may transmit the geographical location information of the terminal obtained by positioning the terminal to the server.

At step 202, the server receives at least one of: the mobile phone number transmitted by the terminal and geographical location information of the terminal obtained by positioning of the terminal.

At step 203, the server acquires a dialect corresponding to the location information.

Optionally, this step may include the following sub-steps.

First, the server determines an area to which the terminal belongs according to the location information.

When the location information received by the server contains a mobile phone number, the server can determine a home location of the mobile phone number according to the digits 4 through 7 of the mobile phone number in China. For example, when the mobile phone number received by the server is “1572282****”, the server determines that the home location of the mobile phone number is “Taizhou” according to “2282” of the mobile phone number, that is, the server determines that the area to which the terminal using this mobile phone number belongs is “Taizhou.” In the U.S., the first 3 digits may be used to determine the home location of the mobile phone. For example, when the mobile phone number received by the server starts with “312” or “312” only, the home location of the mobile phone may be the Chicago area.

When the location information received by the server contains geographical location information of the terminal obtained by positioning of the terminal, the server determines an area to which the terminal belongs according to the geographical location information. For example, if the geographical location information received by the server is “longitude 120.29°, latitude 31.59°”, then the server can determine that the area to which the terminal belongs is “Wuxi” of China according to the latitude and longitude information.

Also, the area may be defined in multiple ways. A city may be defined as the area. “Wuxi” is a city of China, “Wuxi” may be defined as the area for a dialect. Also, a city may be sub-divided into multiple districts and each district is an area. For example, the city of Beijing may be divided into two districts—the southern district and the northern district. The dialect for the southern district may be different from the dialect for the northern district. In addition, the area may be defined by square kilometers. For example, every 2 square kilometers may be defined as an area for the dialect.

When a specific group of people has a certain dialect, the area may also be defined by the group of people. For example, the basketball has certain language among basketball fans. Such language may constitute the dialect for basketball fan. As such, a basketball stadium may be defined as an area. The people inside the basketball stadium may communicate with each other in the basketball dialect.

Second, the server finds a dialect corresponding to the area to which the terminal belongs according to a corresponding relation between the area and the dialect.

The server can pre-store the corresponding relations between the area and the dialect. Thus, after determining the area to which the terminal belongs, the server can read the pre-stored corresponding relations, and determine the dialect corresponding to the area according to the corresponding relations.

There may be multiple dialects in the same area. For example, dialects in “Taizhou” area of China may include “Taixing dialect,” “Jiangyan dialect,” and “Jingjiang dialect.” Accordingly, there may be multiple dialects determined by the server for the area to which the terminal belongs.

In addition, when the terminal is a mobile phone and the mobile phone transmits to the server both the mobile phone number and geographical location information of the terminal obtained by positioning the terminal, the dialect determined by the server according to the mobile phone number may or may not be the same as that determined according to the geographical location information. For instance, the area to which the terminal belongs determined by the server according to a mobile phone number “1572282****” is “Taizhou” of China, while the area to which the terminal belongs determined according to the geographical location information “longitude 120.29°, latitude 31.59° ” is “Wuxi” of China. In this case, the server may determine that the terminal has both the areas of “Taizhou dialect” and “Wuxi dialect” and the two dialects may be determined for the terminal. Thus, there may also be multiple dialects determined by the server as corresponding to the area to which the terminal belongs.

When multiple dialects exist for a terminal, the terminal may be configured to allow the user to select one dialect. For example, a user may choose to use the dialect according to the mobile phone number. By this way, the user may be able to pick and choose the dialect he or she prefers and is getting used to.

At step 204, the server returns the dialect to the terminal.

At step 205, the terminal receives the dialect from the server.

At step 206, the terminal acquires a dialect file corresponding to the dialect.

If there is one dialect, the terminal acquires a dialect file corresponding to the dialect.

If there are multiple dialects, this step may include the following sub-steps.

First, it is detected whether a historically used dialect is included in the multiple dialects.

Second, if the historically used dialect is included the multiple dialects, a dialect file corresponding to the historically used dialect is acquired.

If it is detected that the historically used dialect is included in the multiple dialects, it means that the historically used dialect may be a dialect that conforms to user's habits. Accordingly, the terminal can then acquire the dialect file corresponding to the historically used dialect.

It should be noted that this embodiment is only illustrated by way of example where a terminal acquires a dialect file corresponding to the dialect in the manner described above when there are multiple dialects. Optionally, the terminal can also acquire the dialect file corresponding to the dialect in other manners. For instance, the terminal presents the at least two received dialects to the user, receives a selection that selects one from the multiple dialects by the user, and acquires the dialect file corresponding to the dialect selected. For example, when three dialects of “Taixing dialect,” “Jiangyan dialect” and “Jingjiang dialect” are received by the terminal, the terminal can present the interface as shown in FIG. 2B to a user. When a selection control 22 and a determination control 24 are selected by the user for “Taixing dialect,” the dialect file corresponding to the “Taixing dialect” can be acquired that corresponds to the selection control 22.

Optionally, the step in which the terminal acquires a dialect file corresponding to a dialect may include: detecting whether a dialect file corresponding to the dialect is included in the terminal; and if not, acquiring the dialect file corresponding to the dialect from the server. Optionally, the terminal can also directly acquire the dialect file corresponding to the dialect from the server, and the embodiment is not limiting in this regard.

At step 207, for a default operation item in the user interface, the terminal finds an expression in the dialect file which corresponds to the default operation item.

There may be one or at least two default operation items in the user interface. When there are at least two default operation items, the terminal finds an expression in the dialect file which corresponds to each of the two default operation items. Sometimes, according to the user profile either obtained from the user himself or herself or obtained from a third party, one default dialect may be determined by the system for the terminal. As such, a terminal may only has one dialect. When a terminal's default dialect is determined, the user interface for the terminal may only display the content in determined dialect and the dialect file may only contain expressions for the default dialect.

For instance, referring to FIG. 2C, the user interface includes two default operation items “jin qu kan kan” (“go in and have a look” in English) and “yi hou zai shuo” (“discuss it later” in English), then the expression corresponding to the “jin qu kan kan” found by the terminal in the dialect file is “jin qu chou chou”, and the expression in the dialect file which corresponds to the “yi hou zai shuo” is “hui tou zai shuo”.

At step 208, the terminal displays the user interface including the operation item expressed using an expression described above.

For instance, for the user interface as shown in FIG. 2C, after finding the expression of the default operation item in the dialect file, the terminal can display the interface as shown in FIG. 2D.

An area to which a terminal belongs will typically not change for a short period of time, and the dialect corresponding to the area will not change for the short period of time as well. Thus, in order to avoid the problem that a server needs to frequently determine a dialect corresponding to location information and would thus consume a significant amount of system resources caused by transmitting location information to the server whenever the terminal logs into the applications, the terminal can transmit location information to the server at a predetermined time interval such as every 2 hours or every 5 days or every 3 months. Alternatively, when determining that an area to which a terminal belongs has changed, for example it is determined that the terminal is changed to a different city, the positioning system in the terminal transmits the changed location information to the server and the dialect is thus determined again by using the changed location information. If a mobile phone number is used as an identification for logging-in an application in a terminal, the application in the terminal may transmit the mobile phone number to the server whenever the application is logged in and the mobile phone number is used.

To sum up, in the method provided by this embodiment, location information is transmitted to a server, the server acquires and returns a dialect corresponding to the location information, and a terminal displays a user interface including a dialect operation item according to the received dialect where the dialect operation item is an operation item expressed using an expression in the dialect. This method solves the problems that a default operation item displayed by a terminal may not conform to reading habits of a user and the interface display is not user friendly. By using this method, an operation item is expressed using an expression in a dialect and hence a user interface including a dialect operation item is displayed such that the interface display is more user friendly.

In the method provided by this embodiment, it can be detected whether dialects that a server returns include a historically used dialect, and if so, a dialect file of the historically used dialect is directly acquired, and the historically used dialect may be set to be the dialect for displaying in the terminal directly. The repeat processes for determining and setting the dialect may thus be saved.

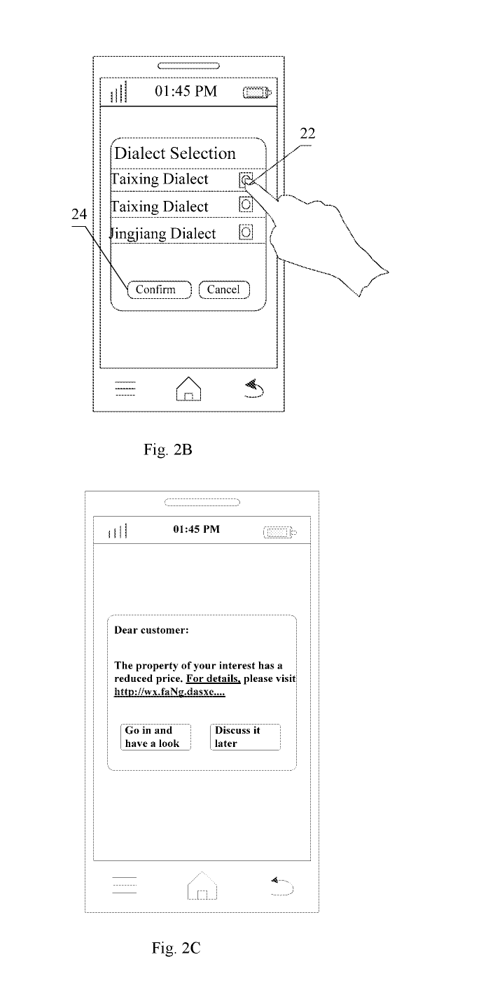

FIG. 3 is a flow chart showing another interface display method according to an exemplary embodiment. This embodiment is illustrated by way of example where a terminal transmits location information to a server in the second manner described above. As shown in FIG. 3, the method may include following steps.

At step 301, the terminal transmits an IP address to a server.

The IP address is used by the server to determine an area to which the terminal belongs according to the IP address and the server acquires and returns a dialect corresponding to the area.

When connected to a network, the terminal can acquire its own IP address, and transmit the IP address to the server.

At step 302, the server receives the IP address transmitted by the terminal.

At step 303, the server acquires a dialect corresponding to the IP address.

Optionally, the step may include the following sub-steps.

First, the server determines the area to which the terminal belongs according to the IP address.

For instance, if the IP address transmitted by the terminal and received by the server is 221.227.72.130, the area to which the terminal belongs can be determined as “Wuxi” of China according to this IP address.

Second, the server finds a dialect corresponding to the area to which the terminal belongs according to a corresponding relation between the area and the dialect.

The server can pre-store the corresponding relations between the area and the dialect. After determining the area to which the terminal belongs, the server can read the pre-stored corresponding relations, and determine the dialect corresponding to the area according to the corresponding relations.

At step 304, the server returns the dialect to the terminal.

At step 305, the terminal receives the dialect from the server.

At step 306, the terminal acquires a dialect file corresponding to the dialect. The dialect file may include the mapping of each display button and text display. For example, the dialect file may include entries and each entry may include a button identification and the dialect text. The text for the button may be in a particular dialect.

If there is one dialect, the terminal acquires a dialect file corresponding to the dialect.

If there are multiple dialects, this step may include the following sub-steps.

First, it is detected whether a historically used dialect is included in the multiple dialects.

Second, if the historically used dialect is included the multiple dialects, a dialect file corresponding to the historically used dialect is acquired.

If the detection shows that the historically used dialect is included in the multiple dialects for the terminal, it means that the historically used dialect may be a dialect that conforms to user's usage habits. Accordingly, the terminal can then acquire the dialect file corresponding to the historically used dialect.

At step 307, for a default operation item in the user interface, the terminal finds an expression in the dialect file which corresponds to the default operation item.

At step 308, the terminal displays the user interface including the operation item expressed using the expression described above.

It should be noted that, the steps 304 to 308 in this embodiment are implemented in a similar manner to the steps 204 to 208 in the above embodiment, and will not be elaborated herein.

To sum up, in the method provided by this embodiment, location information is transmitted to a server, the server acquires and returns a dialect corresponding to the location information, a terminal displays a user interface including a dialect operation item according to the received dialect where the dialect operation item is an operation item expressed using an expression in the dialect. This solves the problems that a default operation item presented by a terminal may not conform to reading habits of a user and the interface display is not user friendly. By using this method, an operation item is expressed using an expression in a dialect and hence a user interface including a dialect operation item is displayed such that the interface display is more user friendly.

In the method provided by this embodiment, it is detected whether the dialect that the server returns includes a historically used dialect, and if so a dialect file of the historically used dialect is directly acquired, and the historically used dialect may be set to be the dialect for displaying in the terminal directly. The repeat processes for determining and setting the dialect may thus be saved.

It's one point to be noted that the above embodiment is only illustrated by way of example where a terminal transmits at least one of: a mobile phone number and geographical location information of the terminal obtained by positioning the terminal to a server or the terminal transmits an IP address to the server. Optionally, the terminal can also transmit an IP address and at least one of: a mobile phone number and geographical location information of the terminal obtained by positioning the terminal to the server.

It's another point to be noted that, in the above embodiment, the steps related to the terminal side can be implemented as a whole as an interface display method at the terminal side, and the steps related to the server side can be implemented as a whole as an interface display method at the server side.

The following disclosure relates to the apparatus, and can be used for implementing method embodiments described above. Reference can be made to the method embodiments of this disclosure for the details that are not disclosed in the apparatus.

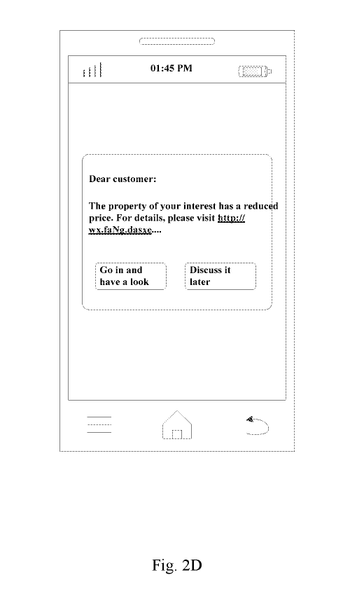

FIG. 4 is a block diagram showing an interface display apparatus according to an exemplary embodiment. The apparatus can be implemented as a terminal (such as a mobile phone, a tablet, a laptop computer, a desktop computer and the like) or a part of it by means of hardware, software, or a combination thereof. The apparatus may include: a transmitting module 410, a receiving module 420 and a displaying module 430.

The transmitting module 410 is configured to transmit location information to a server.

When the terminal is a mobile phone, the location information includes at least one of: a mobile phone number of the terminal and geographical location information of the terminal obtained by positioning the terminal. The mobile phone number is used by the server to determine an area to which the terminal belongs according to home location information of the mobile phone number and the server returns a dialect corresponding to the area. The geographical location information is used by the server to determine an area to which the terminal belongs according to the geographical location information and the server returns a dialect corresponding to the area.

When the terminal is not a mobile phone but has a positioning function, such as a tablet and the like, the location information includes geographical location information of the terminal obtained by positioning the terminal.

When the terminal is the one that has no positioning function but is merely a networking device, such as a desktop computer and the like, the location information includes an IP address used by the terminal in the network. The IP addresses is used by the server to determine an area to which the terminal belongs according to the IP addresses and the server acquires and returns a dialect corresponding to the area.

The receiving module 420 is configured to receive a dialect from the server, where the dialect corresponds to the location information acquired by the server and transmitted by the transmitting module 410.

The dialect is used by the terminal to display a user interface including a dialect operation item according to the dialect, and the dialect operation item is an operation item expressed using an expression in the dialect.

The displaying module 430 is configured to display a user interface including a dialect operation item according to the dialect where the dialect operation item is an operation item expressed using an expression in the dialect received by the receiving module 420. Sometimes, when the expression in dialect and the default option have different lengths, the font size of the display text may be reconfigured according to the number of words. For example, when the number of words is 10 for the expression to be displayed in dialect, the font size for the text may be 12 in Times New Roman. However, when the number of words is 15 for the text expression in another dialect, the font size may be changed automatically to be a smaller font size. For example, the font size may be changed to be 8 in Times New Roman when the number of words is 15.

To sum up, with the apparatus provided by this embodiment, location information is transmitted to a server, the server acquires and returns a dialect corresponding to the location information, a terminal displays a user interface including a dialect operation item according to the received dialect where the dialect operation item is an operation item expressed using an expression in the dialect. This solves the problems that a default operation item presented by a terminal may not conform to reading habits of a user and the interface display is not user friendly. By using the apparatus, an operation item is expressed using an expression in a dialect and hence a user interface including a dialect operation item is displayed such that the interface display is more user friendly.

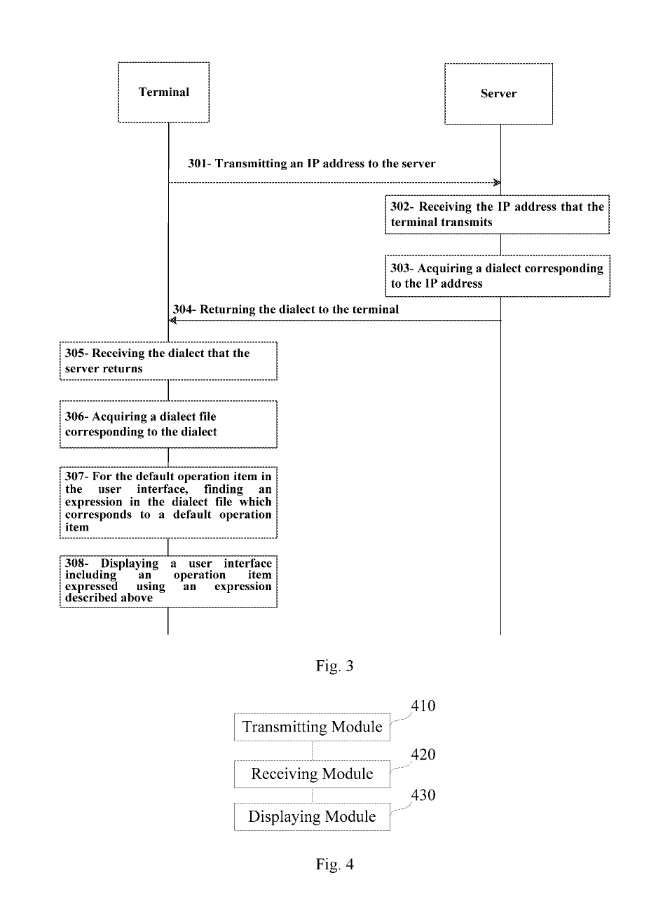

FIG. 5 is a block diagram showing an interface display apparatus according to another exemplary embodiment. The apparatus can be implemented as a terminal (such as a mobile phone, a tablet, a laptop computer, a desktop computer and the like) or a circuitry of a terminal by means of hardware, software, or a combination thereof. The apparatus may include: a transmitting module 510, a receiving module 520 and a displaying module 530.

The transmitting module 510 is configured to transmit location information to a server.

The receiving module 520 is configured to receive a dialect from the server where the dialect corresponds to the location information acquired by the server and transmitted by the transmitting module 510.

The displaying module 530 is configured to display a user interface including a dialect operation item where the dialect operation item is an operation item expressed using an expression in the dialect received by the receiving module 520.

Optionally, the displaying module 530 may include: an acquisition sub-module 531, a finding sub-module 532 and a display sub-module 533.

The acquisition sub-module 531 is configured to acquire a dialect file corresponding to a dialect.

Optionally, the acquisition sub-module 531 may acquire the dialect file corresponding to the dialect by: detecting whether the dialect file corresponding to the dialect is included in the terminal, and if so acquiring the dialect file corresponding to the dialect from the server. Optionally, the acquisition sub-module 531 may also directly acquire the dialect file corresponding to the dialect from the server.

The finding sub-module 532 is configured to, for a default operation item in the user interface, find an expression corresponding to a default operation item in the dialect file acquired in the acquisition sub-module 531.

There may be one or multiple default operation items in the user interface. When there are multiple default operation items, the finding sub-module 532 finds an expression corresponding to each of multiple default operation items in the dialect file.

The display sub-module 533 is configured to display the user interface including the operation item expressed using the expression found by the finding sub-module 532.

Optionally, when there are multiple dialects, the acquisition sub-module 531 is further configured to: detect whether a historically used dialect is included in the multiple dialects, and if the historically used dialect is included multiple dialects, the acquisition sub-module 531 acquires a dialect file corresponding to the historically used dialect.

If the detection shows that the historically used dialect is included in the multiple dialects, it means that the historically used dialect may be a dialect that conforms to user's usage habits. Accordingly, the acquisition sub-module 531 can then acquire a dialect file corresponding to the historically used dialect.

Optionally, the transmitting module 510 is configured to transmit at least one of: a mobile phone number of a terminal and geographical location information of the terminal obtained by positioning the terminal to a server. The mobile phone number is used by the server to determine an area to which the terminal belongs according to the home location information of the mobile phone number.

When the terminal is a mobile phone, the mobile phone transmits at least one of: the mobile phone number and geographical location information of the terminal obtained by positioning the terminal to the server. The mobile phone number is used by the server to determine an area to which the mobile phone belongs according to home location information of the mobile phone number and the server returns a dialect corresponding to the area. The geographical location information is used by the server to determine an area to which the terminal belongs according to the geographical location information and the server returns a dialect corresponding to the area.

A mobile phone number may have a uniform coding format. For example, where digits 4 through 7 of the mobile phone number in China represent an area code that is used to indicate a home location of the mobile phone number. Accordingly, the transmitting module 510 can transmit the mobile phone number to the server. In an example implementation, in order to reduce network resources that need to be occupied when the transmitting module 510 transmits the location information, the transmitting module 510 can just transmit the first 7 digits of the mobile phone number to the server. Also, the transmitting module 510 may just transmits the digits 4-7 of the mobile phone number to the server.

The mobile phone may have different coding formats. Sometimes, the first 3 digits of the mobile phone number may be the area code that can be used to determine the home location of the mobile phone. For example, when the first 3 digits of a mobile phone number in the United States are “312,” the home location for the mobile phone may be in the Chicago area. For this case, to save the network resources, only the first 3 digits of the mobile phone number may be transmitted to the server.

A mobile phone can obtain its own geographical location information (generally represented by latitude and longitude information) by GPS positioning, and the transmitting module 510 can also transmit geographical location information of the terminal obtained by positioning the terminal to the server.

When the terminal is not a mobile phone but has a positioning function, such as a tablet and the like, the transmitting module 510 transmits geographical location information of the terminal obtained by positioning the terminal to a server.

Optionally, the transmitting module 510 may also be configured to transmit an IP address of the terminal to the server, wherein the IP address is used by the server to determine the area to which the terminal belongs according to the IP address and the server acquires and returns the dialect corresponding to the area.

When the terminal is connected to a network, the transmitting module 510 can acquire an IP address of the terminal, and transmit the IP address to the server.

To sum up, by using the apparatus provided by this embodiment, location information is transmitted to a server, the server acquires and returns a dialect corresponding to the location information, and a terminal displays a user interface including a dialect operation item according to the received dialect where the dialect operation item is an operation item expressed using an expression in the dialect. This solves the problems that a default operation item presented by a terminal may not conform to reading habits of a user and the interface display is not user friendly. By using this apparatus, an operation item is expressed using an expression in a dialect and hence a user interface including a dialect operation item is displayed such that the interface display is more user friendly.

In the apparatus provided by this embodiment, it is detected whether a dialect that a server returns includes a historically used dialect, and if so a dialect file of the historically used dialect is directly acquired, and the historically used dialect may be set to be the dialect for displaying in the terminal directly. The repeat processes for determining and setting the dialect may thus be saved.

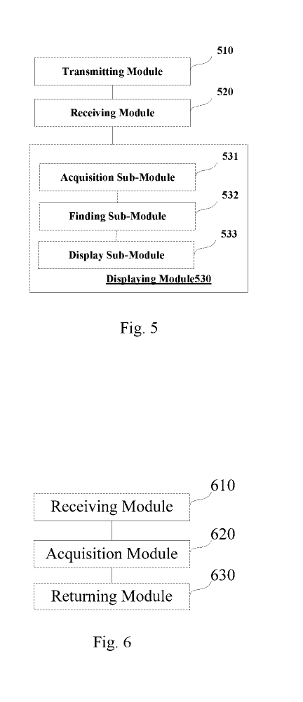

FIG. 6 is a block diagram showing an interface display apparatus according to another exemplary embodiment. The apparatus can be implemented as all or part of a server by means of items of hardware or software, or both. The apparatus may include: a receiving module 610, an acquiring module 620 and a returning module 630.

The receiving module 610 is configured to receive location information of a terminal that the terminal transmits.

When the terminal is a mobile phone, the location information includes at least one of: a mobile phone number of the terminal and geographical location information of the terminal obtained by positioning the terminal where the mobile phone number is used by a server to determine an area to which the terminal belongs according to home location information on the mobile phone number, and the server returns a dialect corresponding to the area, and the geographical location information is used by the server to determine an area to which the terminal belongs according to the geographical location information, and the server returns a dialect corresponding to the area.

When the terminal is the one that has a function of positioning, such as a tablet and the like, besides a mobile phone, the location information includes geographical location information of the terminal obtained by positioning the terminal.

When the terminal is the one that has no function of positioning but is merely network device, such as a desktop computer and the like, the location information includes IP addresses upon the network that the terminal is in. The IP addresses are used by the server to determine the area to which the terminal belongs according to the IP addresses, the server acquires and returns the dialect corresponding to the area.

The acquiring module 620 is configured to acquire a dialect corresponding to the location information received by the receiving module 610.

The returning module 630 is configured to return the dialect that the acquiring module 620 acquires corresponding to the terminal, where the dialect is used by the terminal to display a user interface including a dialect operation item according to the dialect, and the dialect operation item is an operation item expressed using an expression in a dialect.

Accordingly, the apparatus provided by this embodiment is that, by transmitting location information to a server, acquiring and returning by the server a dialect corresponding to the location information, a terminal displays a user interface including a dialect operation item according to the received dialect where the dialect operation item is an operation item expressed using an expression in a dialect; this solves the problems that a default operation item presented by a terminal may not comply with reading habits of a user, and an interface display is thus not user friendly. By using the apparatus, an operation item is expressed by using an expression in a dialect, and hence displaying a user interface including a dialect operation item, such that the interface display is more user friendly.

It's to be noted that the above embodiment is only exemplified by dividing the apparatus implementation into functional modules. In other examples, the above features may be performed by different functional modules according to requirements. Thus, it is possible to divide the content structure of an apparatus into different functional modules or circuitries to complete all or part of functions described above.

With respect to the apparatus in the above embodiments, the specific manners for performing operations for individual modules therein have been described in detail in the embodiments regarding the related methods, and will not be elaborated herein.

An exemplary embodiment of this disclosure also provides an interface display apparatus that is capable of implementing the interface display method provided by this disclosure. The interface display apparatus may include a processor and a memory for storing instructions executable by the processor. The processor is configured to: transmit location information to a server; receive a dialect from the server where the dialect corresponds to the location information that the server acquires, and display a user interface including a dialect operation item where the dialect operation item is an operation item expressed using an expression in a dialect.

Optionally, the processor is configured to: acquire a dialect file corresponding to the dialect, for a default operation item in the user interface, find an expression in the dialect file which corresponds to the default operation item, and display the user interface including the operation item expressed using an the expression.

Optionally, the processor is configured to: detect whether a historically used dialect is included in multiple dialects, and if the historically used dialect is included in the multiple dialects, acquire a dialect file corresponding to the historically used dialect.

Optionally, the processor is configured to: transmit at least one of: home location information of a terminal and geographical location information of the terminal obtained by positioning the terminal to a server.

Optionally, the processor is configured to: transmit an IP address of the terminal to the server where the IP address is used by the server to determine an area to which the terminal belongs and the server acquires and returns a dialect corresponding to the area.

An exemplary embodiment of this disclosure also provides an interface display apparatus that is capable of implementing the interface display method provided by this disclosure. The interface display apparatus may include: a processor and a memory for storing instructions executable by the processor. The processor is configured to: receive location information of a terminal that the terminal transmits, acquire a dialect corresponding to the location information, and return the dialect to the terminal where the dialect is used by the terminal to display a user interface including a dialect operation item according to the dialect, and the dialect operation item is an operation item expressed using an expression in the dialect.

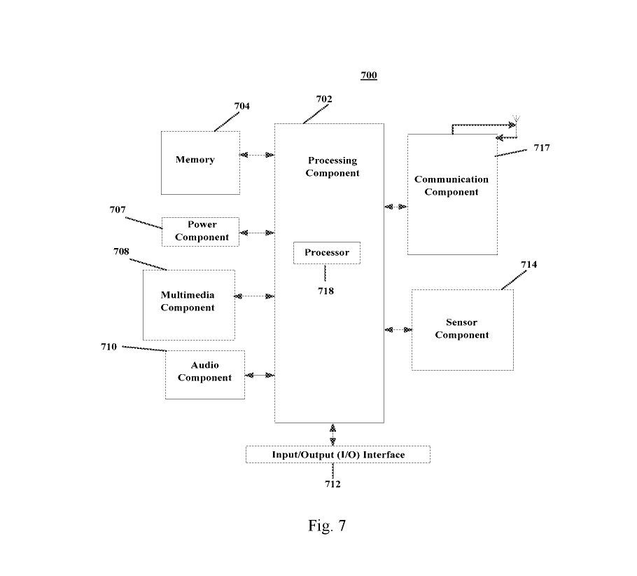

FIG. 7 is a block diagram showing an interface display apparatus according to an exemplary embodiment. For instance, an apparatus 700 can be a mobile phone, a tablet, an electronic reader, a portable computer, a desktop computer and the like.

Referring to FIG. 7, the apparatus 700 may include one or more of the following components: a processing component 702, a memory 704, a power component 707, a multimedia component 708, an audio component 710, an input/output (I/O) interface 712, a sensor component 714, and a communication component 717.

The processing component 702 typically controls overall operations of the apparatus 700, such as the operations associated with display, telephone calls, data communications, camera operations, and recording operations. The processing component 702 may include one or more processors 718 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the apparatus 700. Examples of such data include instructions for any applications or methods operated on the apparatus 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 707 provides power to various components of the apparatus 700. The power component 707 may include a power management system, one or more power sources, and any other components associated with the generation, management, and distribution of power in the apparatus 700.

The multimedia component 708 includes a screen providing an output interface between the apparatus 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the apparatus 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (“MIC”) configured to receive an external audio signal when the apparatus 700 is in an operation mode, such as a call mode, a recording mode, and a voice recognition mode. The received audio signal may be further stored in the memory 704 or transmitted via the communication component 717. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the apparatus 700. For instance, the sensor component 714 may detect an open/closed status of the apparatus 700, relative positioning of components, e.g., the display and the keypad, of the apparatus 700, the sensor component 714 may also detect a change in position of the apparatus 700 or a component of the apparatus 700, a presence or absence of user contact with the apparatus 700, an orientation or an acceleration/deceleration of the apparatus 700, and a change in temperature of the apparatus 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 717 is configured to facilitate communication, wired or wirelessly, between the apparatus 700 and other devices. The apparatus 700 can access a wireless network based on a communication standard, such as WiFi, 2Q or 3Q or a combination thereof. In one exemplary embodiment, the communication component 717 receives a broadcast signal or broadcast associated information from an external broadcast management system via a broadcast channel. In one exemplary embodiment, the communication component 717 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 718 in the apparatus 700, for performing the above-described methods. For example, the non-transitory computer-readable storage medium may be a ROM, a RAM, a CD-ROM, a magnetic tape, a floppy disc, an optical data storage device, and the like.

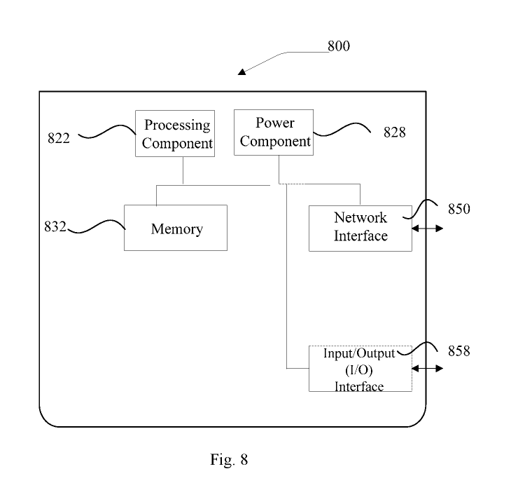

FIG. 8 is a block diagram showing an interface display apparatus according to another exemplary embodiment. Referring to FIG. 8, an apparatus 800 includes a processing component 822 which further includes one or more processors, and memory resources that a memory 832 represents for storing instructions executable by the processing component 822, e.g., applications. The application programs stored in the memory 832 may include one or more modules each corresponding to a set of instructions. In addition, the processing component 822 is configured to execute instructions, so as to implement some of the above interface display method executed by the server.

The apparatus 800 may further include a power component 828 configured to implement a power management of the apparatus 800, a wired or wireless network interface 850 configured to connect the apparatus 800 to a network, and an input/output (I/O) interface 858. The apparatus 800 can be operated based on an operating system stored in the memory 832, e.g., Windows Server™, Mac OS X™, Linux™, FreeBSD™ or the like.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various embodiments can broadly include a variety of electronic and computing systems. One or more embodiments described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Other embodiments will be apparent to those skilled in the art from consideration of the specification and practice disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof.

1. An interface display method, comprising:
transmitting location information to a server;
receiving a dialect from the server, wherein the dialect corresponds to the location information that the server acquires; and
displaying, according to the dialect, a user interface including a dialect operation item, wherein the dialect operation item is an operation item expressed using an expression in the dialect.

2. The method according to claim 1, wherein displaying according to the dialect the user interface including the dialect operation item comprises:
acquiring a dialect file corresponding to the dialect;
for a default operation item in the user interface, finding the expression in the dialect file which corresponds to the default operation item; and
displaying the user interface including the default operation item expressed using the expression.

3. The method according to claim 2, wherein the dialect comprises multiple dialects, wherein acquiring the dialect file corresponding to the dialect comprises:
detecting whether a historically used dialect is included in the multiple dialects; and
if the historically used dialect is included in the multiple dialects, acquiring the dialect file corresponding to the historically used dialect.

4. The method according to claim 1, wherein transmitting the location information to the server comprises: transmitting to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server returns a second dialect corresponding to the second area.

5. The method according to claim 2, wherein transmitting the location information to the server comprises: transmitting to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server returns a second dialect corresponding to the second area.

6. The method according to claim 3, wherein transmitting the location information to the server comprises: transmitting to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server returns a second dialect corresponding to the second area.

7. The method according to claim 1, wherein transmitting location information to the server comprises:
transmitting an Internet Protocol (IP) address of a terminal to the server, wherein the IP address is used by the server to determine an area to which the terminal belongs according to the IP address and the server acquires and returns the dialect corresponding to the area.

8. The method according to claim 2, wherein transmitting location information to the server comprises:
transmitting an Internet Protocol (IP) address of a terminal to the server, wherein the IP address is used by the server to determine an area to which the terminal belongs according to the IP address and the server acquires and returns the dialect corresponding to the area.

9. The method according to claim 3, wherein transmitting location information to the server comprises:
transmitting an Internet Protocol (IP) address of a terminal to the server, wherein the IP address is used by the server to determine an area to which the terminal belongs according to the IP address and the server acquires and returns the dialect corresponding to the area.

10. An interface display method, comprising:
receiving location information of a terminal transmitted by the terminal;
acquiring a dialect corresponding to the location information; and
transmitting the dialect to the terminal, wherein the dialect is used by the terminal to display a user interface including a dialect operation item according to the dialect, and the dialect operation item is an operation item expressed using an expression in the dialect.

11. An interface display apparatus, comprising:
a processor; and
a memory for storing instructions executable by the processor,
wherein the processor is configured to:
transmit location information to a server;
receive a dialect from the server, wherein the dialect corresponds to the location information that the server acquires; and
display a user interface including a dialect operation item according to the dialect, wherein the dialect operation item is an operation item expressed using an expression in the dialect.

12. The apparatus of claim 11, wherein the processor is further configured to:
acquire a dialect file corresponding to the dialect;
for a default operation item in the user interface, find the expression in the dialect file which corresponds to the default operation item; and
display the user interface including the default operation item expressed using the expression.

13. The apparatus of claim 12, wherein the dialect comprises multiple dialects, and the processor is further configured to:
detect whether a historically used dialect is included in the multiple dialects; and
if the historically used dialect is included in the multiple dialects, acquire the dialect file corresponding to the historically used dialect.

14. The apparatus of claim 11, wherein the processor is further configured to transmit to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server returns a second dialect corresponding to the second area.

15. The apparatus of claim 12, wherein the processor is further configured to transmit to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server returns a second dialect corresponding to the second area.

16. The apparatus of claim 13, wherein the processor is further configured to transmit to the server at least one of: a mobile phone number of a terminal and geographical location information of the terminal obtained by positioning the terminal,
wherein the mobile phone number is used by the server to determine a first area to which the terminal belongs according to home location information of the mobile phone number and the server returns a first dialect corresponding to the first area, and the geographical location information is used by the server to determine a second area to which the terminal belongs according to the geographical location information and the server return a second dialect corresponding to the second area.

17. The apparatus of claim 11, wherein the processor is further configured to transmit an Internet Protocol (IP) address of a terminal to the server, wherein the IP address is used by the server to determine an area to which the terminal belongs according to the IP address and the server acquires and returns the dialect corresponding to the area.

18. The apparatus of claim 12, wherein the processor is further configured to transmit an Internet Protocol (IP) address of a terminal to the server, wherein the IP address is used by the server to determine an area to which the terminal belongs according to the IP address and the server acquires and returns the dialect corresponding to the area.

19. The apparatus of claim 13, wherein the processor is further configured to transmit an Internet Protocol (IP) address of a terminal to the server, wherein the IP address is used by the server to determine an area to which the terminal belongs according to the IP address and the server acquires and returns the dialect corresponding to the area.
